(19) United States
(12) Patent Application Publication
(10) Pub. No.: US 2014/0273863 A1
(43) Pub. Date: Sep. 18, 2014

(54) SMART HELMET WITH MOBILE COMMUNICATOR INTEGRATION

(71) Applicant: LUIZZI BROS. SEALCOATING & STRIPING LLC, Albany, NY (US)

(72) Inventor: Bryant Luizzi, Troy, NY (US)

(73) Assignee: LUIZZI BROS. SEALCOATING & STRIPING LLC, Albany, NY (US)

(21) Appl. No.: 13/832,664

(22) Filed: Mar. 15, 2013

(51) Int. Cl. H04M 1/05; H04B 7/26

(52) U.S. Cl. CPC H04M 1/05; H04B 7/26
USPC 455/66.1

(57) ABSTRACT

Disclosed herein is a protective helmet that includes a protective outer shell, a head cavity and a computer processor housed within the protective helmet. Further disclosed is a transmitter and a receiver located in the protective helmet that is configured to establish a communication with a mobile communicator. Further disclosed is a microphone connected to the computer processor and located in a mouth region of the head cavity, the microphone configured to convert sound to an electronic transmission and provide the electronic transmission to the computer processor. Additionally, at least one speaker connected to the computer processor and located in an ear region of the head cavity. The computer processor is configured to receive verbal instructions from the microphone. The instructions are configured to control the mobile communicator. Moreover, the computer processor is configured to receive information from the mobile communicator and provide this information to the speakers in the form of an audio transmission.

### FIELD OF THE DISCLOSURE

The subject matter disclosed herein relates generally to helmets. More particularly, the subject matter relates to a smart helmet that may integrate with a mobile communicator.

### BACKGROUND OF THE DISCLOSURE

Motorcycles do not support route navigation, or emergency features that are supported by most new automobiles. This is largely due to the fact that motorcycle operation is much louder than most enclosed automobiles. Furthermore, a motorcycle has a higher degree of alertness required for proper operation than a typical enclosed motor vehicle. Thus, these features would not be accessible to motorcyclists even if a motorcycle manufacturer attempted to integrate them somewhere in the cockpit of a motorcycle. Additionally, most motorcyclists are required by law, or choose for the purpose of safety, to wear a helmet. Helmets prevent motorcyclists from safely communicating on cell phones, even using safer “hands-free” communication, while operating their vehicle.

Thus, a system or device that could provide motorcyclists and other vehicle operators with various navigation, safety and communication features would be well received in the art.

### BRIEF DESCRIPTION

According to one embodiment, a protective helmet includes a protective outer shell; a head cavity; a computer processor housed within the protective helmet; a transmitter and a receiver located in the protective helmet that is configured to establish a communication with a mobile communicator; a microphone connected to the computer processor and located in a mouth region of the head cavity, the microphone configured to convert sound to an electronic transmission and provide the electronic transmission to the computer processor; and at least one speaker connected to the computer processor and located in an ear region of the head cavity; wherein the computer processor is configured to receive verbal instructions from the microphone, wherein the instructions are configured to control the mobile communicator.

According to another embodiment, a protective helmet comprises: a protective outer shell; a head cavity; a computer processor housed within the protective helmet; a transmitter and a receiver located in the protective helmet that is configured to establish a communication with a mobile communicator; a microphone connected to the computer processor and located in a mouth region of the head cavity, the microphone configured to convert sound to an electronic transmission and provide the electronic transmission to the computer processor; and at least one speaker connected to the computer processor and located in an ear region of the head cavity; and wherein the computer processor is configured to receive information from the mobile communicator and provide this information to the speakers in the form of an audio transmission.

According to another embodiment, a method of integrating a helmet with a mobile communicator comprises: providing a protective helmet that includes: a protective outer shell; a head cavity; a computer processor housed within the protective helmet; a transmitter and a receiver located in the protective helmet; a microphone connected to the computer processor and located in a mouth region of the head cavity, the microphone configured to convert sound to an electronic transmission and provide the electronic transmission to the computer processor; and at least one speaker connected to the computer processor and located in an ear region of the head cavity; providing a mobile communicator; establishing a communication between the protective helmet and the mobile communicator; receiving verbal instructions from the microphone; and controlling the mobile communicator with the verbal instructions.

### BRIEF DESCRIPTION OF THE DRAWINGS

The subject matter which is regarded as the invention is particularly pointed out and distinctly claimed in the claims at the conclusion of the specification. The foregoing and other features and advantages of the invention are apparent from the following detailed description taken in conjunction with the accompanying drawings in which:

FIG. 1 depicts a perspective view of a helmet in use according to one embodiment;

FIG. 2 depicts a perspective view of an inside of the helmet of FIG. 1 when looking down into a head cavity of the helmet according to one embodiment;

FIG. 3 depicts a computer system in the helmet of FIG. 1 according to one embodiment;

FIG. 4 depicts schematic view of a system including the helmet of FIGS. 1-2 according to one embodiment; and

FIG. 5 depicts a perspective view of the helmet of FIGS. 1-3 charging in a standard power outlet according to one embodiment.

### DETAILED DESCRIPTION

A detailed description of the hereinafter described embodiments of the disclosed apparatus and method are presented herein by way of exemplification and not limitation with reference to the Figures.

Referring first to FIGS. 1 and 2, a helmet 10 is shown. FIG. 1 shows the outside of the helmet 10 in use. FIG. 2 shows the inside of a helmet 10 when looking down into the head cavity 11. The helmet 10 shown in the exemplary embodiment in the Figures is a motorcycle helmet. However, it should be understood that the helmet 10 may be worn by a wearer 12 when the wearer is riding a motorcycle, snowmobile, dirtbike, go-cart, all-terrain vehicle (ATV), dune buggy, or the like. The helmet 10 may also be a skiing or snowboarding helmet. The helmet 10 is shown as a full face motorcycle helmet. In other embodiments, the helmet may also be a modular helmet, an open face helmet or a half helmet. It is further contemplated that the principles described in the present disclosure hereinafter may be applied to any other type of protective helmet wearable by a person.

The helmet 10 includes an outer shell 14 that is configured to protect the wearer from impact or collision. The outer shell 14 may be made of plastic or fiber materials. Within the outer shell 14 may be an expanded polystyrene (EPS) foam material 16 that cushions the wearer's head upon impact. A fabric lining (not shown) may cover the EPS foam material 16 for comfort of the wearer 12. However, the helmet 10 is shown without this lining in order to reveal the components located within the EPS material 16. In the embodiment shown, the helmet includes a transparent face shield 18 that allows a wearer to see. Thus, the helmet 10 shown in the Figures may include all of the protective structure of a typical full face motorcycle helmet known to those in the art.

The helmet 10 may further include a speaker system that includes at least a left speaker 20 and a right speaker 22. These speakers 20, 22 may be located within the helmet 10. For example, the inner EPS foam material 16 may be cut out in order to accommodate the speakers 20, 22 near the ear portions of the helmet 10. Thus, the speakers 20, 22 may be located near the ears of the wearer 12 in use. The speakers 20, 22 may be configured to emit sound at a high enough decibel level that the wearer 12 can hear clearly during operation of a motorcycle or similar vehicle. In one embodiment, a thinner layer of the EPS foam material 16 may be located between the speakers 20, 22 and the wearer 12.

The helmet 10 may further include a microphone 24 or other sound receiver. The microphone 24 may be located on the inside of the helmet 10 in a similar manner to the speakers 20, 22, with a space cut out from the EPS foam material 16. The microphone 24 may be located near a mouth region of the helmet and may be configured to receive vocal sound input from the voice of the wearer 12. The microphone 24 may be configured to discern a voice command from the ambient sound of a vehicle in use. In other words, the microphone 24 may include noise cancellation technology. It should be understood that the microphone 24 may be any type of user input interface that receives a vocal input from the user and converts the input into an electronic transmission. Furthermore, the microphone 24 may be a directional microphone located to the side of the mouth region in the case that the helmet 10 is not a full face helmet but is instead modular or a half helmet.

The helmet 10 may further include a computer system 26 housed within. FIG. 3 illustrates the computer system 26 (examples of which may be various embodiments of described hereinbelow) used for performing a method or process for integrating the helmet 10 with a mobile communicator 30. The computer system 26 may comprise a processor 38, an input device 40 coupled to the processor 38, an output device 42 coupled to the processor 38, and memory devices 44 and 46 each coupled to the processor 38. The input device 40 may be, among other things, a touch screen, buttons, or the microphone 24. The output device 42 may be, among other things, a display or the speakers 20, 22. The memory devices 44 and 46 may be, among other things, a hard disk, a floppy disk, a magnetic tape, an optical storage such as a compact disc (CD) or a digital video disc (DVD), a dynamic random access memory (DRAM), a read-only memory (ROM), etc. The memory device 44 may include a computer code 48. The computer code 48 includes algorithms or a predetermined set of parameters for performing a process for monitoring a communication system. The processor 38 may execute the computer code 48. The memory device 46 may include input data 50. The input data 50 includes input required by the computer code 48. The output device 42 displays output from the computer code 48. Either or both memory devices 44 and 46 (or one or more additional memory devices not shown in FIG. 3) may comprise the algorithm or predetermined parameters and may be used as a computer usable medium (or a computer readable medium or a program storage device) having a computer readable program code embodied therein and/or having other data stored therein, wherein the computer readable program code comprises the computer code 48. Generally, a computer program product (or, alternatively, an article of manufacture) of the computer system 26 may comprise said computer usable medium (or said program storage device).

While FIG. 3 shows the computer system 26 as a particular configuration of hardware and software, any configuration of hardware and software, as would be known to a person of ordinary skill in the art, may be utilized for the purposes stated herein in conjunction with the particular computer system 26 of FIG. 3. For example, the memory devices 44 and 46 may be portions of a single memory device rather than separate memory devices.

It should be noted that the embodiments described hereinbelow illustrate the architecture, functionality, and operation of possible implementations of systems, methods and computer program products according to various described and depicted embodiments. In this regard, each block in the block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagram illustrations, can be implemented by special purpose hardware-based systems that perform the specified functions or acts, or combinations of special purpose hardware and computer instructions.

In one embodiment, the computer system 26 may be housed in the back of the helmet 10 or any other appropriate location. In one embodiment, the location may be determined to be the location that is least likely to get impacted in an accident, such as the back portion of the helmet 10 or directly on top of the helmet 10. The computer system 26 may be in operable communication with both the speakers 20, 22 and the microphone 24.

The helmet 10 may also include a transceiver 28 that is in operable communication with the computer system 26. The transceiver 28 may be a wireless transceiver that is configured to communicate wirelessly with other devices. However, the communication system between the transceiver 28 and the computer system 26 may either be wired or wireless. The transceiver 28 may be configured to receive and transmit signals wirelessly to another device such as a mobile communicator 30, shown in FIG. 1, and the schematic of FIG. 4. The mobile communicator 30 may be a cell phone, smartphone, tablet, laptop computer, personal digital assistant, music playing device (Ipod®) or the like. The mobile communicator 30 may be any type of device that is configured to communicate with other devices, either via a wire or wirelessly. In one embodiment, the transceiver 28 may establish a Bluetooth connection with the mobile communicator 30 in order to send and receive data, signals, or other information. It should also be understood that the transceiver 28 may not be wireless at all. Rather, the helmet 10 may have a USB or other type of wired port that directly connects to the mobile communicator 30 via a wire. Thus, the transceiver 28 may be this wire port interface (not shown). It should be understood that the transceiver 28 may be divided into its two separate components: a receiver and a transmitter.

The helmet 10 may be configured to receive verbal or audio instructions from a wearer through the microphone 24. The instructions may be processed by the computer processor 26 and sent to the mobile communicator 30 via the transceiver 28. The instructions may be configured to control the mobile communicator 30 in some way. For example, the wearer 12 of the helmet 10 may speak into the microphone 24. These instructions may be processed and forwarded by the processor 26 in order to tell the mobile communicator 30 to open a particular program on the mobile communicator 30. For example, the instructions may open a GPS or mapping program in the mobile communicator 30. Once this program is open, the computer processor 26 may be configured to receive information from the mobile communicator 30 and provide this information to the speakers 20, 22 in the form of an audio transmission. In other words, the mobile communicator 30 may communicate with the processor 26 via the transceiver 28 to provide information to the processor 26 that is then forwarded to the speakers 20, 22 in the helmet 10. In this way, the mobile communicator 30 provides audio information to the wearer 12. Thus, the helmet 12 may take advantage of the processing power of the mobile communicator 30 and applications found on the mobile communicator 30 to provide information to the wearer 12 during operation of the vehicle. In the GPS embodiment, the mobile communicator 30 may provide audio information to the wearer such as directional information, turn by turn navigation, and the like. The wearer can provided new destination information to the mobile communicator 30. The mobile communicator 30 may further automatically acquire destination information from its internal GPS navigation system to be used as a present location for navigation purposes.

In other embodiments, the instructions from the wearer may place a call with an existing contact on the mobile communicator 30. In this embodiment, an audio transmission from the existing contact on the call is output by the speakers 20, 22 and wherein the microphone 24 is configured to receive an audio input by the wearer 12 of the helmet 10. The audio input is provided to the mobile communicator 30 by the transmitter. Thus, the wearer and the existing contact can have live audio communication while the wearer is operating the motorcycle or other vehicle.

In one embodiment, the wearer 12 may be required to press an activation button 32 found on a side of the helmet 10. The activation button 32 may then activate the microphone 24 by turning it on and readying it to receive a vocal input. In one embodiment, this activation button 32 may turn on the microphone 24 indefinitely. The activation button 32 may also be configured to turn off this microphone as an input the second time it is pressed or otherwise activated. A second button 34 may be configured to establish a connection with the mobile communicator 30. This button 34 may also be configured to end the connection with the mobile communicator 30. These activation buttons 32, 34 may be located along the bottom rim of the helmet 10 for easy access to be pressed by the wearer 12 while operating a vehicle simultaneously. In other embodiments, no activation buttons 32, 34 may be required. The connection may be automatically established permanently when the mobile communicator 30 is in the same vicinity of the helmet 30.

Thus, in one example of use, the wearer 12 puts on the helmet 10 and sits on his motorcycle (not shown). The wearer 12 may then press the activation button 34 to establish a connection between the helmet 10 and the mobile communicator 30 that may be stored in the wearer's pocket. The wearer 12 may then press the activation button 32 which activates his microphone 24 in the helmet 10. The wearer 12 may then provide verbal instructions to the mobile communicator 30 such as stating “please activate my navigation application.” The processor 26 may then process these instructions and forward them to the mobile communicator 30 in a form that is understood by the mobile communicator 30. The mobile communicator 30 may then run the navigation application and send a voice signal back to the helmet 10 that is processed by the processor 26 and forwarded to the speakers 20, 22. This voice signal may tell the wearer 12 to “Please provide your destination.” The wearer 12 may then verbally state his destination. From there the mobile communicator 30 may provide this routing information that may be heard in the speakers 20, 22 of the helmet 10 to guide the wearer 12 during operation of his vehicle. It should be understood that the mobile communicator 30 may include a GPS program that is operational during the navigation program so that the location of the wearer 12 is always known by the mobile communicator and routes can be calculated and recalculated automatically based on the known current location.

In other embodiments, the helmet 10 may be configured to automatically warn the wearer 12 of upcoming traffic patterns that may be discernible through the wireless capabilities of the mobile communicator 30. Likewise, the helmet 10 may be configured to provide weather information to the wearer. In other embodiments, the helmet 10 may automatically play music on the speakers 20, 22 via an internet streaming program found on the mobile communicator 30. In still other embodiments, the helmet 10 may be configured to provide any other type of audio information that the wearer would desire that was discernible by the mobile communicator 30.

FIG. 4 shows a schematic of the communication structure between the helmet 10 and the mobile communicator 10 including the internal communications between the elements of the helmet 10. For example, this schematic shows that the helmet 10 includes the processor 26 connected to the transceiver 28, the microphone 24, the speakers 22, 24. The helmet 10 connected to the mobile communicator 30 which also includes a transceiver 52 and its own processor 54 as known to those skilled in the art. Software 56 may be included on the mobile communicator 30 that allows it to communicate with the processor 26 of the helmet 10.

In one embodiment, the mobile communicator 30 may include software that allows above described communication between the mobile communicator 30 and the helmet 10. This software may be, for example, a downloadable application provided for the mobile communicator 30 via methods of installation known in the art of mobile communication. In another embodiment, no new software may be necessary as the helmet 10 may be configured to interact with factory installed programs such as SIRI®. In this case, the button 32 may be configured to activate the voice command program (such as SIRI®) of the mobile communicator 30. In other embodiments, the helmet 10 may be programmed with software that is configured to perform the functionality described herein. In other words, the memory devices 44, 46 may be configured to store executable programs which perform the various functions described.

In another embodiment (not shown), the helmet 10 may come included as an upgrade option when a person buys a motorcycle or other vehicle. In this case, the helmet 10 may be integrated with the motorcycle such that the buttons 32, 34 to activate the helmet 10 are no longer needed to be placed in the helmet 10 but may be included close to or on the handlebars of the motorcycle to prevent a person from needing to take their hands off the handle bars of the motorcycle while riding in order to activate the helmet 10. In this embodiment, the helmet 10 may be configured to be in communication with a processor found integrated in the motorcycle. For example, there may be a navigation system which is located in the cockpit of the motorcycle that establishes a connection with the helmet 10 in the same way described hereinabove with respect to the mobile communicator 30.

In some embodiments, safety features may be included in the helmet 10 which cause the mobile communicator 30 to automatically call for emergency help in the case that the helmet 10 detects an accident. In this embodiment, there may be software or hardware coded into the processor that automatically is configured to detect crashes and automatically send out this signal to the connected mobile communicator 30. The software or hardware may be configured to detect one or more conditions that are unusual and would likely or definitively mean that the wearer was involved in an accident.

Shown in FIG. 5 is the helmet 10 being charged in a standard power outlet 58. The helmet 10 may include a connector 60 that is configured to mate with a power chord 62. In other embodiments, the power chord 62 may be configured to plug into a 5V power source that may be found in the motorcycle itself. In other embodiments, the power chord connector may also be configured to receive a USB chord in order to transfer data to the helmet 10 that can be stored on memory 44, 46 in the helmet 10. For example, software updates may be provided to the helmet 10 via this USB connection. Thus, the helmet 10 may also be connectable to a laptop, desktop, or tablet computer in order to load software updates into the helmet 10. The helmet 10 may include a separate USB socket for connecting to a USB chord. The helmet 10 may include a battery 64 stored in the foam material 16 configured to power the processor 26 the microphone 24, the speakers 20, 22. It should be understood that the power chord 62, the USB chord, and the like may be sold together with, or separately from, the helmet 10.

In another embodiment, the face shield of the helmet 10 may include a portion in one of the corners, for example, that is configured to display certain graphical images transferred by the mobile communicator 30. For example, the mobile communicator 30 may provide navigation maps on this corner of the face shield. The images displayed on this corner of the face shield may remain in a semi-transparent state in order to not impair the vision of the wearer 12 during operation of a vehicle. In this embodiment, it should be understood that the face shield may include electronic pixel displays in order to display these images thereon in the above described corner. These pixels may further be transparent when the display functionality is not in use so that the wearer can see through the face shield. In use, the display may be semi transparent, so that the wearer can see through the display and so that the display does not fully block vision. Those skilled in the art of image display will understand the many variations contemplated herein.

Elements of the embodiments have been introduced with either the articles “a” or “an.” The articles are intended to mean that there are one or more of the elements. The terms “including” and “having” and their derivatives are intended to be inclusive such that there may be additional elements other than the elements listed. The conjunction “or” when used with a list of at least two terms is intended to mean any term or combination of terms. The terms “first” and “second” are used to distinguish elements and are not used to denote a particular order.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

I claim:

1. A protective helmet comprising:
a protective outer shell;
a head cavity;
a computer processor housed within the protective helmet;
a transmitter and a receiver located in the protective helmet that is configured to establish a communication with a mobile communicator;
a microphone connected to the computer processor and located in a mouth region of the head cavity, the microphone configured to convert sound to an electronic transmission and provide the electronic transmission to the computer processor; and
at least one speaker connected to the computer processor and located in an ear region of the head cavity; and
wherein the computer processor is configured to receive verbal instructions from the microphone, wherein the instructions are configured to control the mobile communicator.

2. The protective helmet of claim 1, wherein the computer processor is configured to receive information from the mobile communicator and provide this information to the speakers in the form of an audio transmission.

3. The protective helmet of claim 1, wherein the protective helmet is configured to establish a wireless communication with the mobile communicator.

4. The protective helmet of claim 1, wherein the verbal instructions are configured to open a mapping program in the mobile communicator.

5. The protective helmet of claim 1, wherein the verbal instructions are configured to place a call with an existing contact of the mobile communicator, wherein an audio transmission from the existing contact on the call is output by the at least one speaker, and wherein the microphone is configured to receive an audio input by a wearer of the helmet, and wherein the audio input is provided to the mobile communicator by the transmitter.

6. The protective helmet of claim 1, further comprising a face shield, wherein the face shield is configured to display a graphical image transferred by the mobile communicator.

7. The protective helmet of claim 1, further comprising an activation button for activating the microphone of the helmet.

8. The protective helmet of claim 7, wherein the activation button is further configured to establish a connection between the helmet and the mobile communicator.

9. The protective helmet of claim 1, wherein the processor is configured to automatically cause the mobile communicator 30 to call for emergency help if at least one condition occurs.

10. A protective helmet comprising:
a protective outer shell;
a head cavity;
a computer processor housed within the protective helmet;
a transmitter and a receiver located in the protective helmet that is configured to establish a communication with a mobile communicator;
a microphone connected to the computer processor and located in a mouth region of the head cavity, the microphone configured to convert sound to an electronic transmission and provide the electronic transmission to the computer processor; and
at least one speaker connected to the computer processor and located in an ear region of the head cavity; and
wherein the computer processor is configured to receive information from the mobile communicator and provide this information to the speakers in the form of an audio transmission.

11. The protective helmet of claim 10, wherein the computer processor is configured to receive verbal instructions from the microphone, wherein the instructions are configured to control the mobile communicator.

12. The protective helmet of claim 10, wherein the protective helmet is configured to establish a wireless communication with the mobile communicator.

13. The protective helmet of claim 10, wherein the verbal instructions are configured to open a mapping program in the mobile communicator.

14. The protective helmet of claim 10, wherein the verbal instructions are configured to place a call with an existing contact of the mobile communicator, wherein an audio transmission from the existing contact on the call is output by the at least one speaker, and wherein the microphone is configured to receive an audio input by a wearer of the helmet, and wherein the audio input is provided to the mobile communicator by the transmitter.

15. The protective helmet of claim 10, further comprising a face shield, wherein the face shield is configured to display a graphical image transferred by the mobile communicator.

16. The protective helmet of claim 10, further comprising an activation button for activating the microphone of the helmet.

17. The protective helmet of claim 16, wherein the activation button is further configured to establish a connection between the helmet and the mobile communicator.

18. The protective helmet of claim 10, wherein the processor is configured to automatically cause the mobile communicator 30 to call for emergency help if at least one condition occurs.

19. A method of integrating a helmet with a mobile communicator comprising:
providing a protective helmet that includes:
a protective outer shell;
a head cavity;
a computer processor housed within the protective helmet;
a transmitter and a receiver located in the protective helmet;
a microphone connected to the computer processor and located in a mouth region of the head cavity, the microphone configured to convert sound to an electronic transmission and provide the electronic transmission to the computer processor; and
at least one speaker connected to the computer processor and located in an ear region of the head cavity;
providing a mobile communicator;
establishing a communication between the protective helmet and the mobile communicator;
receiving verbal instructions from the microphone; and
controlling the mobile communicator with the verbal instructions.

20. The method of claim 19, further comprising:
receiving information from the mobile communicator; and
providing the received information to the speakers in the form of an audio transmission.
